(19) United States
(12) Patent Application Publication
(10) Pub. No.: US 2015/0303007 A1
(43) Pub. Date: Oct. 22, 2015

(54) LIGHT EMITTING SWITCH APPARATUS AND METHOD FOR MOLDING SWITCH KNOB FOR LIGHT EMITTING SWITCH APPARATUS

(71) Applicant: YAZAKI CORPORATION, Tokyo (JP)

(72) Inventor: Takahiro HORI, Makinohara-shi (JP)

(73) Assignee: YAZAKI CORPORATION, Tokyo (JP)

(21) Appl. No.: 14/690,792

(22) Filed: Apr. 20, 2015

(30) Foreign Application Priority Data
Apr. 21, 2014 (JP) 2014-086999

(51) Int. Cl. H01H 9/16; H01H 11/00; B29C 31/10

(52) U.S. Cl. CPC H01H 9/161; B29C 31/10; H01H 11/00; H01H 2219/036; H01H 2229/00

(57) ABSTRACT

A light emitting switch apparatus includes a circuit, a switch that opens and closes a contact point of the circuit, a light emitting bulb that emits light, and a switch knob as an operation part of the switch. The switch knob includes a primary molded part configuring the translucent part and a secondary molded part configuring a design part other than the translucent part. The primary molded part includes a projection on an inside surface of the primary molded part projected along an opening-closing direction of a molding mold of the primary molded part. The projection is integrally molded with the primary molded part. The primary molded part and the secondary molded part are integrally molded by a multicolor molding method.

### CROSS REFERENCE TO RELATED APPLICATION

This application is based on Japanese Patent Application (No. 2014-086999) filed on Apr. 21, 2014, the contents of which are incorporated herein by reference. Also, all the references cited herein are incorporated as a whole.

### BACKGROUND OF THE INVENTION

1. Technical Field

One or more embodiments of the present invention relate to a light emitting switch apparatus applied to, for example, vehicle-mounted electrical equipment, and a method for manufacturing a switch knob for the light emitting switch apparatus.

2. Background Art

A light emitting switch apparatus applied to vehicle-mounted electrical equipment is described in, for example, the following Patent Reference 1.

As shown in FIG. 7, this light emitting switch apparatus 100 includes a circuit substrate 102 received in a cabinet 101, a switch body 103 formed on the circuit substrate 102, a light emitting bulb 104 which is formed on the circuit substrate 102 and is turned on and off with opening-closing operation of the switch body 103, and a switch knob 106 which is configured movably in response to the switch body 103 through a spring 105 interposed between the circuit substrate 102 and the switch knob 106 and is made by forming a translucent part 106a for transmitting light of the light emitting bulb 104 and an other design part 106b by the so-called multicolor molding method (two-color molding method), and by projecting the translucent part 106a from an outside surface of the design part 106b, the so-called touch typing can be achieved to improve operability.

Patent Reference 1 is JP-A-2003-346585.

### SUMMARY OF THE INVENTION

However, in the related-art light emitting switch apparatus 100, since the switch knob 106 is formed in substantially a plate shape, in the case of molding the switch knob 106, when a mold is changed after molding of a primary molded part configuring the translucent part 106a, that is, when a movable mold is released from a primary molding mold (fixed mold) together with the primary molded part and is joined to a secondary molding mold (fixed mold), the primary molded part is brought into close contact and is sucked with the primary molding mold due to the mold release from the primary molding mold and thereby, the primary molded part drops out of the movable mold to cause positional deviation etc. As a result, the appearance of the design part 106b at the time of secondary molding may be deteriorated.

The invention has been devised by focusing attention on such a technical problem, and one of objects of the invention is to provide a light emitting switch apparatus etc. capable of improving the appearance of a design part of a switch knob formed by a multicolor molding method.

According to the invention, there is provided a A light emitting switch apparatus including: a housing; a substrate configuring a predetermined circuit; a switch configured to open and close a contact point of the circuit; a light emitting bulb that emits light based on power fed from an outside; and a switch knob configuring an operation part of the switch, wherein the substrate, the switch, and the light emitting bulb are received inside the housing, the light of the light emitting bulb is transmitted through a translucent part formed on an operation surface of the switch knob, the switch knob includes a primary molded part configuring the translucent part and a secondary molded part configuring a design part other than the translucent part, the primary molded part includes a projection on an inside surface of the primary molded part projected along an opening-closing direction of a molding mold of the primary molded part, the projection being integrally molded with the primary molded part, and the primary molded part and the secondary molded part are integrally molded by a multicolor molding method.

By forming the projection on the inside surface of the primary molded part, the projection acts as resistance in mold release at the time of a mold change in the case of secondary molding, with the result that trouble in which the primary molded part drops out of the molding mold (movable mold) associated with the mold release can be reduced.

As one preferable aspect of the invention herein, the projection may be formed in such a shape as to surround alight emission part of the light emitting bulb or a light beam of the light emitting bulb.

By such a configuration, the area of contact with the projection in the molding mold (movable mold) can be ensured larger, with the result that the resistance at the time of the mold release can be increased more, and the primary molded part in the molding mold can properly be held more surely.

Also, by such a configuration, the light of the light emitting bulb can be blocked (collected) by the projection, and there is a merit capable of efficiently transmitting the light of the light emitting bulb from the translucent part.

Also, the switch knob is preferably molded by a method having a first step of integrally molding a projection projected from an inside surface of the primary molded part along a mold opening-closing direction together with the primary molded part by filling a first cavity defined between a first fixed mold and a movable mold with a first resin material, a second step of releasing the movable mold from the first fixed mold to perform mold opening after the first step, a third step of joining the movable mold to a second fixed mold to perform mold clamping after the second step, and a fourth step of forming the secondary molded part by filling a second cavity defined between the second fixed mold, the primary molded part and the movable mold with a second resin material after the third step.

By such molding, the projection acts as the resistance at the time of the mold release at the time of changing from the first fixed mold to the second fixed mold, with the result that the trouble in which the primary molded part drops out of the movable mold associated with the release of the movable mold from the first fixed mold can be reduced.

According to embodiments of the invention, the projection acts as the resistance at the time of the mold release at the time of the mold change in the case of the secondary molding, with the result that dropping of the primary molded part associated with the mold release can be reduced. Accordingly, good secondary molding can be performed to improve the appearance of the design part of the switch knob.

### BRIEF DESCRIPTION OF THE DRAWINGS

FIG. 1 is an exploded perspective view of a vehicle-mounted lighting apparatus to which a light emitting switch apparatus according to an embodiment of the invention is applied.

FIG. 2 is a perspective view of the vehicle-mounted lighting apparatus to which the light emitting switch apparatus according to the embodiment of the invention is applied viewed from the front side.

FIG. 3 is a perspective view of the vehicle-mounted lighting apparatus shown in FIG. 2 viewed from the back side.

FIGS. 4A and 4B show a light emitting structure of a switch knob shown in FIG. 1. FIG. 4A is a perspective view, and FIG. 4B is a longitudinal sectional view of FIG. 4A.

FIGS. 5A to 5C show a single body of the switch knob shown in FIG. 1. FIG. 5A is a plan view, FIG. 5B is a bottom view, and FIG. 5C is a longitudinal sectional view.

FIGS. 6A to 6C show steps of molding the switch knob shown in FIGS. 5A to 5C. FIG. 6A is a diagram showing a first step of performing primary molding, FIG. 6B is a diagram showing a second step of releasing a movable mold from a first fixed mold, FIG. 6C is a diagram showing a third step of joining the movable mold to a second fixed mold, and FIG. 6D is a diagram showing a fourth step of performing secondary molding.

FIG. 7 is a longitudinal sectional view of a related-art light emitting switch apparatus.

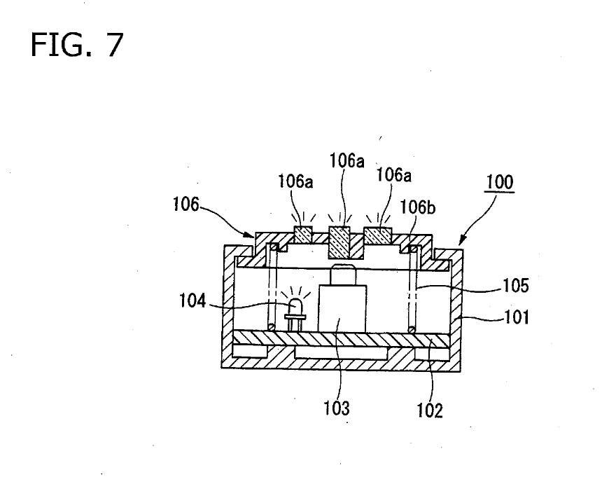

### DETAILED DESCRIPTION OF THE EXEMPLARY EMBODIMENTS

An embodiment of a light emitting switch apparatus according to the invention will hereinafter be described in detail based on the drawings. In addition, in the following embodiment, the case of applying the light emitting switch apparatus to a vehicle-mounted lighting apparatus (concretely, a map lamp) will be described by way of example.

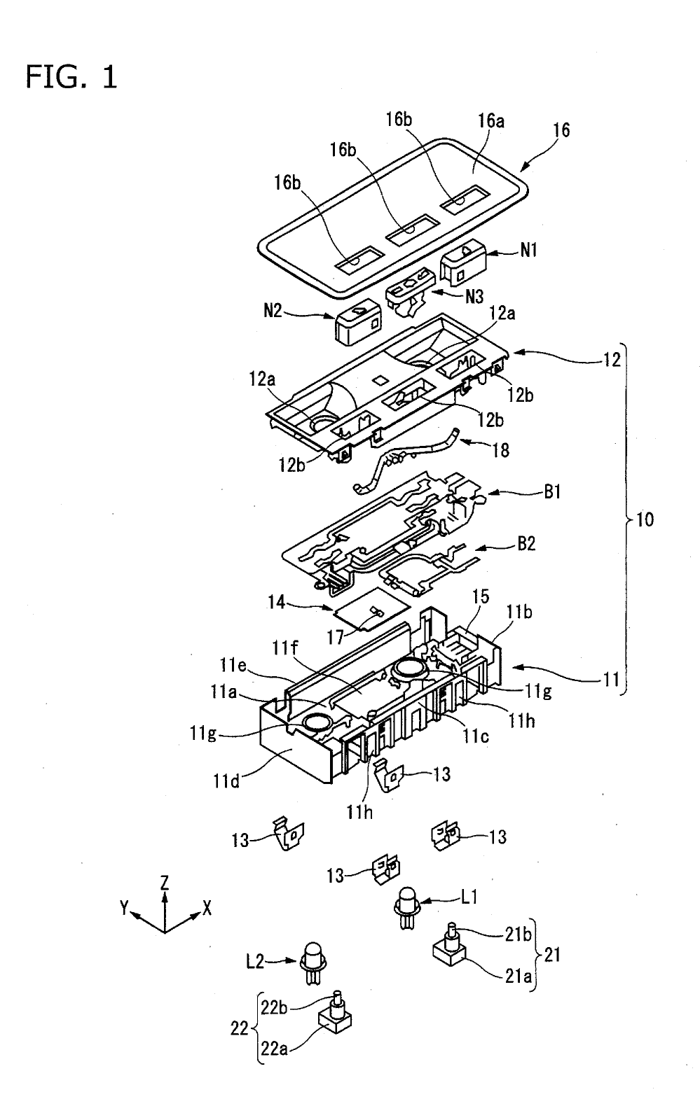

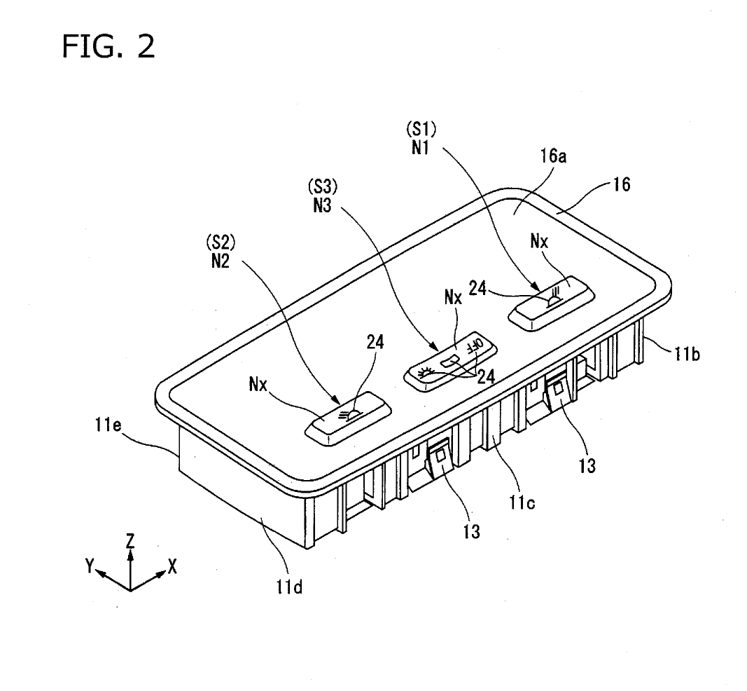

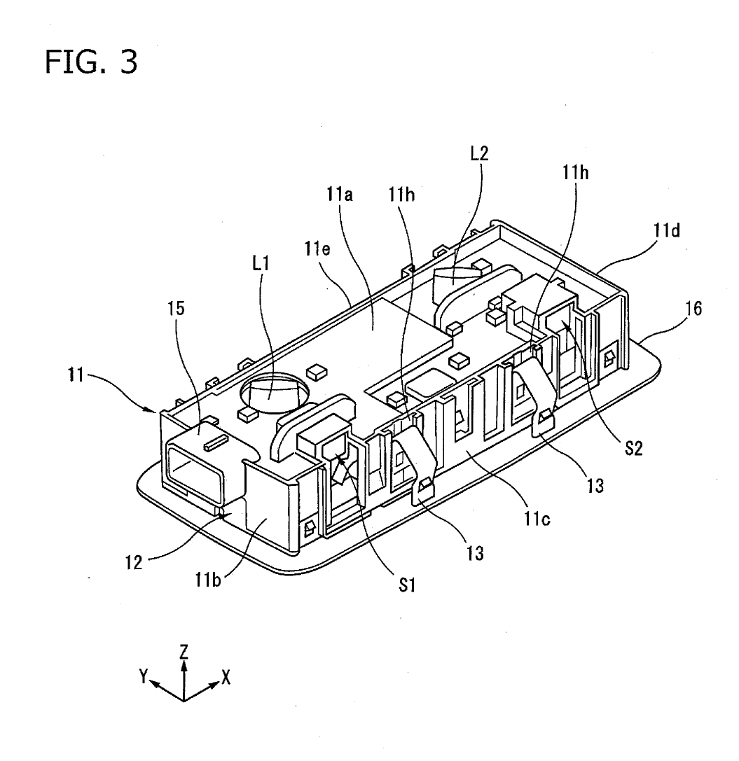

FIG. 1 is an exploded perspective view of the map lamp which is the vehicle-mounted lighting apparatus to which the light emitting switch apparatus according to the embodiment of the invention is applied, and FIG. 2 is a perspective view of the map lamp viewed from the front side, and FIG. 3 is a perspective view of the map lamp viewed from the back side. In addition, the coordinate axes of X, Y, Z shown in the drawings indicate the reference of directions in the following description.

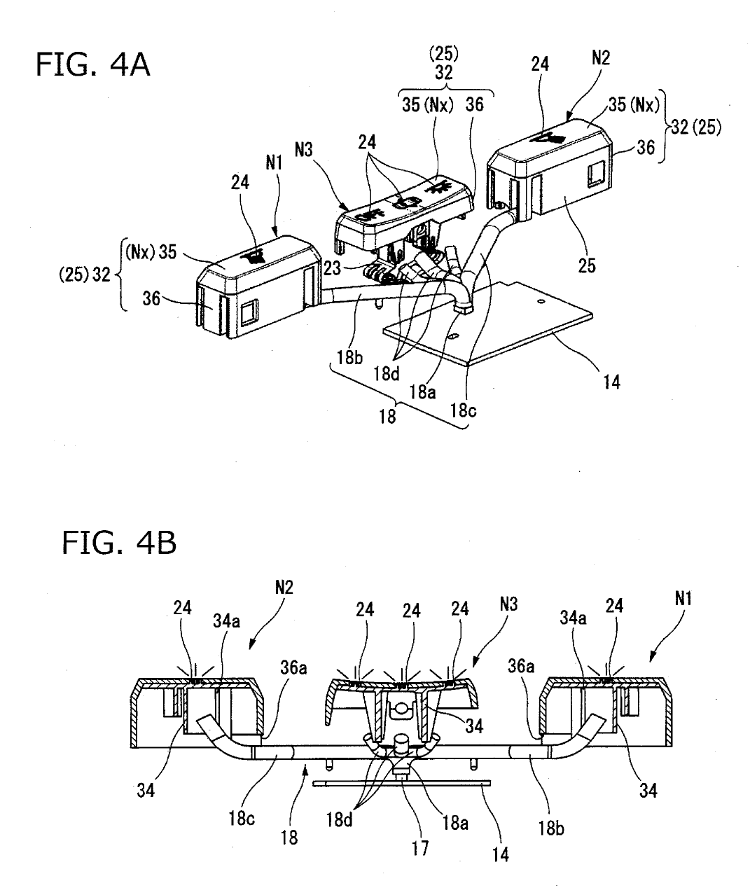

That is, the map lamp shown in FIGS. 1 to 3 includes a housing 10 made of a housing body 11 configured to be opened upwardly (a positive direction of Z axis) and a cover member 12 for closing an opening of the housing body 11, plural clips 13 attached to the outside of the housing 10 and used for vehicle mounting (attachment to a vehicle body) of the housing 10, a circuit substrate 14 received and arranged in substantially the center of the inside of the housing 10, a first bus bar B1 as a main bus bar connected to an external power source etc. (not shown) through a connector 15 formed integrally to the housing body 11 and used for power feeding and power distribution to a pair of lighting bulbs L1, L2 described below and a second bus bar B2 as a sub bus bar used for power feeding and power distribution to the circuit substrate 14, first to third switches S1 to S3 received and arranged inside the housing 10, a pair of lighting bulbs L1, L2 turned on and off by opening and closing of the first and second switches S1, S2, a lens member 16 formed so as to cover the cover member 12 from the outside and used for diffusion etc. of a light beam of each of the lighting bulbs L1, L2, a light emitting diode (hereinafter abbreviated as an “LED”) 17 which is a light emitting bulb used for light emission of each of the switch knobs N1 to N3 through a translucent part 24 (described below) of each of the switches S1 to S3, and a prism 18 for distributing (see FIGS. 4A and 4B) a light beam of the LED 17 to each of the switch knobs N1 to N3.

The housing body 11 has a bottom wall 11a with substantially a rectangular shape, and first to fourth side walls 11b to 11e erected in each side of the bottom wall 11a, and the cover member 12 is attached and fixed to the opening edge of the upper end of the housing body 11. Also, substantially the center position of the bottom wall 11a is provided with substantially a flat-shaped substrate attachment part 11f for placing and fixing the circuit substrate 14 and also, a pair of bulb attachment holes 11g, 11g used for attachment and detachment of each of the lighting bulbs L1, L2 is respectively bored in both end sides of the substrate attachment part 11f. Further, a clip attachment groove 11h used for insertion and fixing of each of the clips 13 is recessed in each of the outsides of the second and fourth side walls 11c, 11e.

The cover member 12 has substantially a plate shape, and a pair of bulb insertion holes 12a, 12a for causing the distal end of each of the lighting bulbs L1, L2 to face the outside of the housing 10 is bored in a position opposed to each of the bulb attachment holes 11g, 11g in the side of the fourth side wall 11e and also, first to third switch insertion holes 12b with substantially rectangular shapes for causing the side of an operation surface Nx of each of the switch knobs N1 to N3 to face the outside of the housing 10 are bored in positions opposed to each of the switches S1 to S3 in the side of the second side wall 11c.

The circuit substrate 14 is constructed by printed wiring of a conductor pattern (not shown) to a substrate made of a non-conductive resin material typified by a glass epoxy resin, and the LED 17 is mounted in substantially the center of a surface (side surface of the positive direction of Z axis) of the circuit substrate 14.

Both of the first bus bar B1 and the second bus bar B2 are constructed by resin molding of a metal substrate, and while one end side of each of the bus bars is electrically connected to the external power source etc. (not shown) through the connector 15, the other end side of the first bus bar B1 is electrically connected to each of the switch bodies 21, 22 and each of the lighting bulbs L1, L2, and the other end side of the second bus bar B2 is electrically connected to the circuit substrate 14, respectively.

The first and second switches S1, S2 are the so-called push switches, and include switch bodies 21, 22 for opening and closing contact points by on-off operation of operation parts 21b, 22b formed movably relatively to pedestal parts 21a, 22a, and the first and second switch knobs N1, N2 which are attached and fixed to the operation parts 21b, 22b of the switch bodies 21, 22 and are used for operation of each of the operation parts 21b, 22b, and each of the lighting bulbs L1, L2 can be individually turned on by each of the switches S1, S2.

The third switch S3 is the so-called slide switch, and includes a contact 23 used for switching of plural (three in the embodiment) contact points, and the third switch knob N3 which is attached and fixed to the contact 23 and is used for operation of this contact 23. In addition, this third switch S3 is means for switching turn-on modes of both of the lighting bulbs L1, L2, and is constructed so that movement to a one side position (turn-on mark) turns on both of the lighting bulbs L1, L2 regardless of opening and closing of a vehicle door and movement to an intermediate position (door opening mark) automatically turns on and off both of the lighting bulbs L1, L2 with opening and closing of the vehicle door and movement to the other side (OFF mark) turns off both of the lighting bulbs L1, L2 regardless of opening and closing of the vehicle door.

In the first and third switch knobs N1 to N3, particularly as shown in FIGS. 4A and 4B, the translucent part 24 which has a bottomed square cylindrical shape and is made of a translucent resin material and is represented by a character, a graphic, etc. used for display of the contents of each of the switches S1 to S3 by transmitting light of the LED 17, and a design part 25 made of a colored opaque resin material are formed by the so-called multicolor molding method (two-color molding method). In other words, each of these switch knobs N1 to N3 includes a primary molded part 31 as a base formed in substantially a plate shape by the translucent resin material, and a secondary molded part 32 made by molding the opaque resin material on the primary molded part 31. In addition, the following detailed description of the primary molded part 31 and the secondary molded part 32 will be made conveniently by taking the first switch knob N1 as an example.

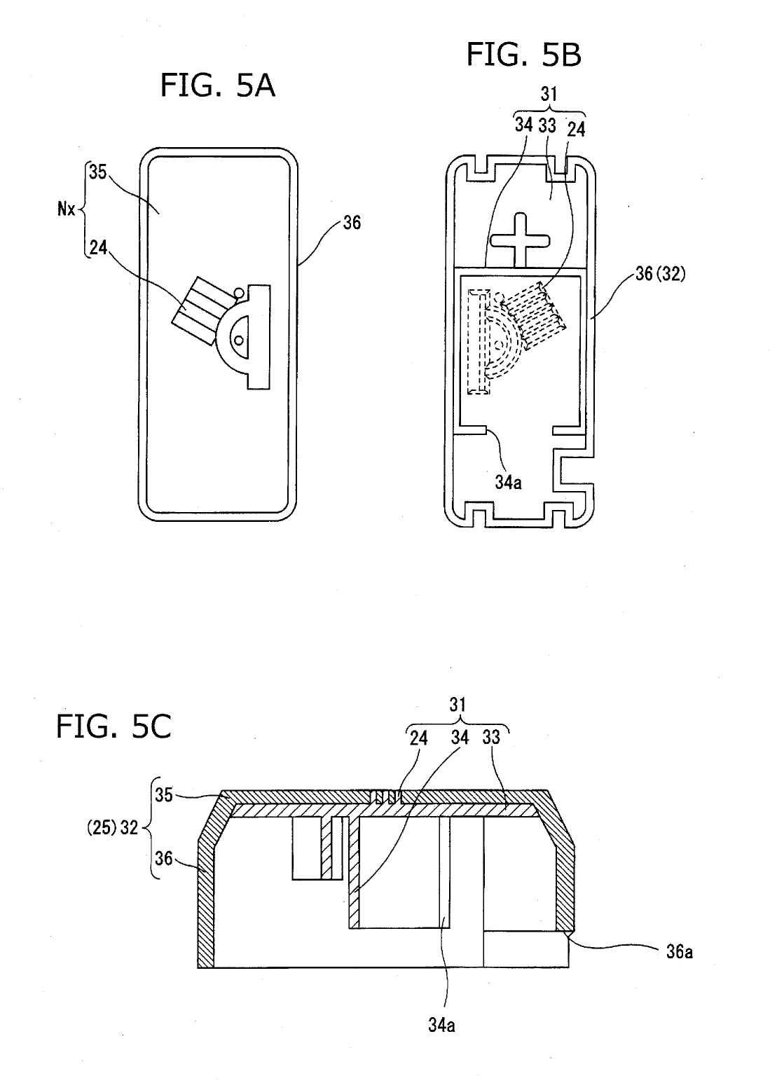

Particularly as shown in FIGS. 5A to 5C, the primary molded part 31 has a base 33 formed in substantially a flat plate shape, the translucent part 24 represented by the character, the graphic, etc. facing the operation surface Nx by being projected to the front (outside surface) of the base 33, and a rib 34 as a projection projected to the back (inside surface) of the base 33 and constructed so as to extend along an opening-closing direction of a molding mold (a movable mold D3 described below) substantially perpendicularly from the inside surface of the base 33, and the base 33, the translucent part 24 and the rib 34 are integrally molded. Also, the rib 34 is formed in a transverse cross section with substantially a rectangular shape and is constructed so that the distal end of the prism 18 (a first distribution part 18b described below) faces the inside through a notch 34a formed in a part of the outer periphery. That is, light of the LED 17 distributed by the prism 18 can be blocked (collected) by forming this rib 34 so as to surround substantially the whole periphery of the distal end of the prism 18.

The secondary molded part 32 has a contact part 35 which is formed in a state overlapping with the outside surface of the base 33 of the primary molded part and constructs the operation surface Nx by forming the same plane as the distal surface of the translucent part 24, and a skirt part 36 constructed so as to face the inside of the housing 10 by extending longer than the rib 34 from the outer periphery of the contact part 35 toward the back side of the base 33, and the contact part 35 and the skirt part 36 are integrally formed. In addition, a notch 36a is recessed in the distal end of one side surface constructing the skirt part 36, and the distal end of the prism 18 (the first distribution part 18b described below) is configured to be introduced into the skirt part 36 through the notch 36a.

As shown in FIGS. 1 and 2, the lens member 16 is formed in substantially a plate shape by a transparent resin material, and is attached and fixed to the upper end of the housing 10. And, a lens part 16a used for diffusion etc. of a light beam of each of the lighting bulbs L1, L2 inserted into each of the bulb insertion holes 12a, 12a is formed in a position opposed to each of the bulb insertion holes 12a, 12a in the side of the fourth side wall 11e and also, first to third switch exposure holes 16b with substantially rectangular shapes for causing the operation surface Nx of each of the switch knobs N1 to N3 inserted into each of the switch insertion holes 12b to face the outside are bored in positions opposed to each of the switch insertion holes 12b in the side of the second side wall 11c.

As shown in FIGS. 1 and 4B, the LED 17 emits light based on electric power of the external power source (not shown) fed through the second bus bar B2, and its light passes through the translucent part 24 of each of the switch knobs N1 to N3 to thereby be used for display of the contents of each of the switches S1 to S3 in a dark place, for example, during night driving.

Particularly as shown in FIGS. 4A and 4B, the prism 18 has a collection part 18a attached and fixed to the circuit substrate 14 so as to surround a light emission part of the LED 17, and first to third distribution parts 18b to 18d which are branched and formed from the collection part 18a toward the first to third switch knobs N1 to N3 and distribute alight beam of the LED 17 to each of the switch knobs N1 to N3, integrally formed by a transparent resin material. In addition, the third distribution part 18d can distribute the light beam of the LED 17 to each of the translucent parts 24 of the third switch knob N3 by being further branched and formed toward each of the translucent parts 24 of the third switch knob N3.

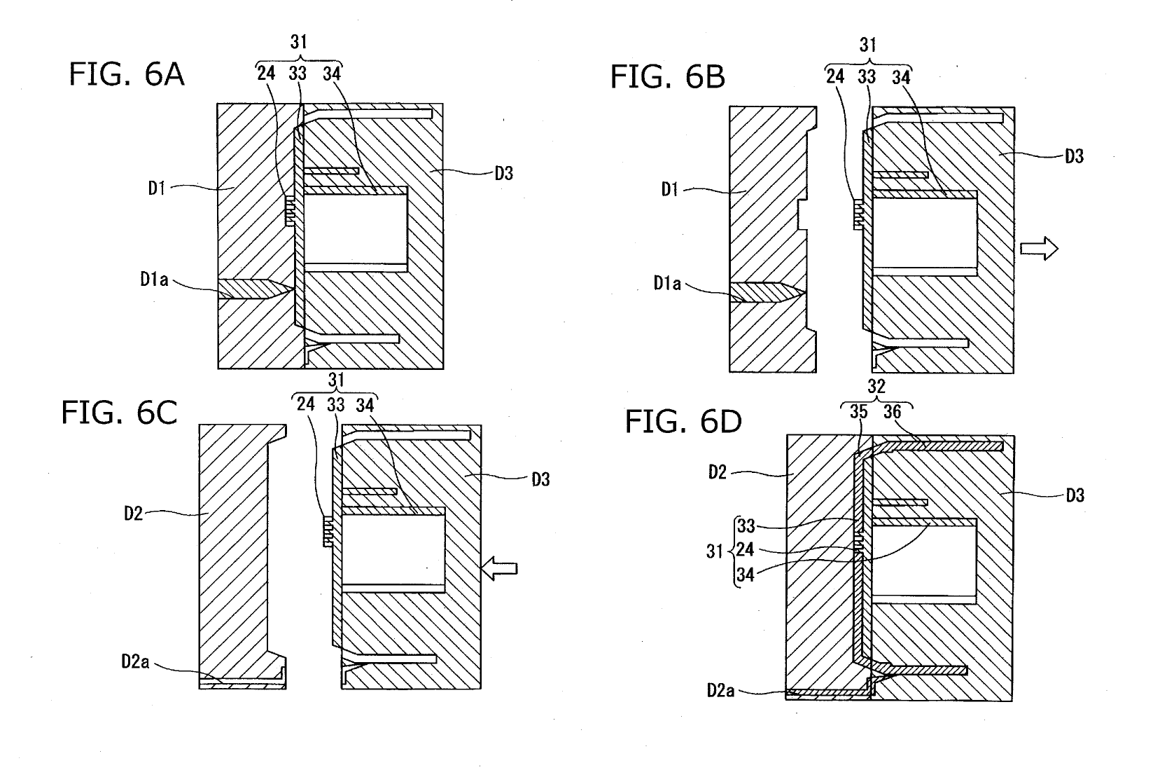

A method for molding the first switch knob N1 will hereinafter be described based on FIGS. 6A to 6D.

First, as shown in FIG. 6A, the movable mold D3 is joined to a first fixed mold D1 used for primary molding to perform mold clamping, and a first cavity defined between both of the molds D1, D3 is filled with the translucent resin material which is a first resin material from an inlet D1a of the first fixed mold D1 and thereby, the primary molded part 31 is molded (a first step).

Next, as shown in FIG. 6B, the movable mold D3 is released from the first fixed mold D1 to perform mold opening (a second step).

At this time, the embodiment projects the rib 34 extending from the inside surface of the base 33 along the mold opening-closing direction in the primary molded part 31 and thereby, all of the inside and outside surfaces of the rib 34 make close contact with the movable mold D3 to act as resistance to a mold release direction, and can resist a force (suction force) of close contact with the first fixed mold D1 associated with the mold release. Accordingly, trouble in which, for example, the primary molded part 31 drops out of the movable mold D3 is reduced, and the primary molded part 31 is properly held in the movable mold D3.

Subsequently, the movable mold D3 is moved to a standby position of a second fixed mold D2 as opposed to the second fixed mold D2 used for secondary molding, and is joined to the second fixed mold D2 to perform mold clamping as shown in FIG. 6C (a third step).

Then, as shown in FIG. 6D, a second cavity defined between the second fixed mold D2, the primary molded part 31 and the movable mold D3 is filled with the opaque resin material which is a second resin material from an inlet D2a of the second fixed mold D2 and thereby, the secondary molded part 32 is molded (a fourth step).

Finally, the movable mold D3 is released from the second fixed mold D2 to perform mold opening, and the first switch knob N1 is taken out, and molding of the first switch knob N1 is completed (a fifth step).

As described above, in the map lamp, the rib 34 extending from the inside surface of the primary molded part 31 along the mold release direction of the movable mold D3 is projected to the inside surface of the primary molded part 31 in the first switch knob N1 and thereby, the rib 34 acts as resistance at the time of the mold release of the movable mold D3 at the time of a mold change (the time of changing from the first fixed mold D1 to the second fixed mold D2) in the case of secondary molding, with the result that trouble such as positional deviation or dropping of the primary molded part 31 out of the movable mold D3 associated with the mold release is reduced, and the primary molded part 31 can properly be held in the movable mold D3. Accordingly, good secondary molding can be performed to improve the appearance of the design part 25 of the first switch knob N1 (this similarly applies to the second and third switch knobs N2, N3).

Further, in the embodiment, the rib 34 is constructed so as to surround the distal end of the prism 18 (the first distribution part 18b) corresponding to the light emission part of the LED 17, with the result that the area of contact with the movable mold D3 can be ensured larger. Accordingly, the resistance at the time of the mold release can be increased more, and the primary molded part 31 can properly be held more surely.

Moreover, since the rib 34 is constructed so as to surround the distal end of the prism 18 and block (collect) light of the LED 17 as described above, there is a merit capable of efficiently transmitting the light of the LED 17 from the translucent part 24.

The invention is not limited to the configuration illustrated in the embodiment described above and particularly, a concrete configuration (for example, shapes, positions or the number of ribs) of the rib 34 can be changed freely according to specifications etc. of a target of application without departing from the gist of the invention.

What is claimed is:

1. A light emitting switch apparatus comprising:
a housing;
a substrate configuring a predetermined circuit;
a switch configured to open and close a contact point of the circuit;
a light emitting bulb that emits light based on power fed from an outside; and
a switch knob configuring an operation part of the switch, wherein
the substrate, the switch, and the light emitting bulb are received inside the housing,
the light of the light emitting bulb is transmitted through a translucent part formed on an operation surface of the switch knob,
the switch knob includes a primary molded part configuring the translucent part and a secondary molded part configuring a design part other than the translucent part,
the primary molded part includes a projection on an inside surface of the primary molded part projected along an opening-closing direction of a molding mold of the primary molded part, the projection being integrally molded with the primary molded part, and
the primary molded part and the secondary molded part are integrally molded by a multicolor molding method.

2. The light emitting switch apparatus according to claim 1, wherein the projection is formed in such a shape as to surround a light emission part of the light emitting bulb or a light beam of the light emitting bulb.

3. A method for molding a switch knob for a light emitting switch apparatus, the method comprising:
a first step of integrally molding
a primary molded part configuring a translucent part for transmitting light of a light emitting bulb and
a projection projected from an inside surface of the primary molded part along a mold opening-closing direction
by filling a first cavity defined between a first fixed mold and a movable mold with a first resin material;
a second step of releasing the movable mold from the first fixed mold to perform mold opening after the first step;
a third step of joining the movable mold to a second fixed mold to perform mold clamping after the second step; and
a fourth step of forming a secondary molded part configuring a design part other than the translucent part by filling a second cavity defined between the second fixed mold, the primary molded part and the movable mold with a second resin material after the third step.
